(19) United States
(12) Patent Application Publication
(10) Pub. No.: US 2023/0082791 A1
(43) Pub. Date: Mar. 16, 2023

(54) VEHICLE AND METHOD OF DRIVER ASSISTANCE FUNCTION CONTROL FOR THE SAME

(71) Applicants: Hyundai Motor Company, Seoul (KR); Kia Corporation, Seoul (KR)

(72) Inventor: Seo Yeon Kim, Gimpo (KR)

(21) Appl. No.: 17/879,504

(22) Filed: Aug. 2, 2022

(30) Foreign Application Priority Data
Sep. 16, 2021 (KR) 10-2021-0124066

(51) Int. Cl. B60W 40/08; B60W 50/16

(52) U.S. Cl. CPC B60W 40/08; B60W 50/16; B60W 2540/221; B60W 2540/043; B60W 2050/143

(57) ABSTRACT

The present disclosure relates to a vehicle where a driver assistance function can be controlled differently according to the physical characteristic of the driver, and a method for controlling the same function. One embodied method for controlling a driver assistance function may comprise steps of obtaining at least one of body-reaction state information and manipulation disability state information, the body-reaction state information related to a driver's situation cognition and reaction and the manipulation disability state information being for physical disability in relation to manipulation of a vehicle; selecting at least one assistance level corresponding to the obtained information among a plurality of assistance levels, each level corresponding to a different driver assistance function; and conducting control of the vehicle based on the selected at least one assistance level.

### CROSS-REFERENCE TO RELATED APPLICATION

This application is based on and claims under 35 U.S.C. § 119(a) the benefit of Korean Patent Application No. 10-2021-0124066, filed on Sep. 16, 2021, which is hereby incorporated by reference as if fully set forth herein.

### TECHNICAL FIELD

The present disclosure relates to a vehicle where a driver assistance function can be controlled differently according to the physical characteristic of the driver, and a method for controlling the same function.

### BACKGROUND

Recently, as becoming an aging society, the number of elderly drivers (for example, drivers aged 60 or older) is rising. Generally, the elderly drivers have low cognitive function or reduced reaction speed, and also reduced muscle strength and, in more severe case, disabled body parts. A relevant research presents that the rate of rear-end or unprotected-left-turn rear-end crashes is higher in the elderly drivers group compared to the other age groups.

Of course, some of elderly drivers may be in a physical state appropriate to drive a car, and also there may be some younger drivers who experience the similar troubles due to their physical characteristics or disability.

Recently-manufactured vehicles have various advanced driver assistance systems (ADAS) to interfere with driving in specific situations to prevent an accidental situation from happening, or avoid rapidly therefrom or reduce the damage. However, since it is common that the conventional systems are designed and manufactured with their detailed settings made fixedly according to normal drivers, or even if the settings adjustable, the adjustment is made individually through complicated manipulations for each function, the conventional systems are less effective or inconvenient for others including elderly drivers.

### SUMMARY

One object of the present disclosure is to provide with a vehicle where a driver assistance function can be controlled differently according to the physical characteristics of the driver, and a method for controlling the same function.

Additional advantages, objects, and features of the disclosure will be set forth in part in the description which follows and in part will become apparent to those having ordinary skill in the art upon examination of the following or may be learned from practice of the disclosure. The objects and other advantages of the disclosure may be realized and attained by the structure particularly pointed out in the written description and claims hereof as well as the appended drawings.

To achieve the object, as embodied and broadly described herein, a method for controlling a driver assistance function may comprise the steps of obtaining at least one of body-reaction state information and manipulation disability state information, the body-reaction state information related to a driver's situation cognition and reaction and the manipulation disability state information being for physical disability in relation to manipulation of a vehicle; selecting at least one assistance level corresponding to the obtained information among a plurality of assistance levels, each level corresponding to a different driver assistance function; and conducting control of the vehicle based on the selected at least one assistance level.

For example, the plurality of assistance levels comprise at least two of a first level accompanied by pedal sensitivity control and speed limiting; a second level for providing with a path recommendation avoiding a specific turn; a third level for activating haptic or auditory output in response to detected surrounding information; a fourth level for enlarging a sensor-based alert output range; and a fifth level for preparing all the time information for emergency report.

For example, the obtaining step comprises a step of receiving as input the driver's age information as the body-reaction state information.

For example, the obtaining step further comprises a step of receiving as input information by body part as the body-reaction state information and the manipulation disability state information.

For example, the method further comprises a step of conducting the control of the vehicle according to default settings in case where the age information is not input, or the information by body part is not input nor does the age information satisfy a predetermined elder-age threshold.

For example, the step of receiving the information by body part comprises the steps of: receiving as input at least one of the driver's visual-acuity information and auditory-acuity information as the body-reaction state information; and receiving as input disabled body part information as the manipulation disability state information.

For example, the step of selecting the assistance level comprises a step of selecting the third and the fourth levels in case where at least one of the visual-acuity information and the auditory-acuity information is below a predetermined threshold.

For example, the step of selecting the assistance level comprises a step of selecting the first level in case where the disabled body part information is input.

For example, the method further comprises a step of conducting a reaction test in the vehicle as so selected by the driver, wherein the selection of the assistance level is made with a result of the test taken further into consideration.

For example, the step of selecting the assistance level comprises a step of selecting the first, the second, the fourth and the fifth levels in case where the reaction speed is not enough according to the result of the test.

For example, the step of selecting the assistance level comprises a step of selecting the second, the fourth, and the fifth levels in case where the reaction speed is enough according to the result of the test.

For example, for each assistance level, whether or not to apply is individually selected.

A computer-readable storage medium according to one embodiment of the present disclosure stores a program for implementing the methods described above.

Also, a vehicle according to an embodiment of the present disclosure comprises an input device configured to obtain at least one of body-reaction state information and manipulation disability state information, the body-reaction state information related to a driver's situation cognition and reaction and the manipulation disability state information being for physical disability in relation to manipulation of a vehicle; a first controller configure to select at least one assistance level corresponding to the obtained information among a plurality of assistance levels, each level corresponding to a different driver assistance function; and a second controller configured to conduct control of the vehicle based on the selected at least one assistance level.

For example, the plurality of assistance levels comprise at least two of: a first level accompanied by pedal sensitivity control and speed limiting; a second level for providing with a path recommendation avoiding a specific turn; a third level for activating haptic or auditory output in response to detected surrounding information; a fourth level for enlarging a sensor-based alert output range; and a fifth level for preparing all the time information for emergency report.

For example, the input device receives as input the driver's age information as the body-reaction state information.

For example, the input device receives as input information by body part as the body-reaction state information and the manipulation disability state information.

For example, the first controller controls the second controller to conduct the control of the vehicle according to default settings in case where the age information is not input, or the information by body part is not input nor does the age information satisfy a predetermined elder-age threshold.

For example, the input device, as the information by body part, receives as input at least one of the driver's visual-acuity information and auditory-acuity information as the body-reaction state information, and disabled body part information as the manipulation disability state information.

For example, the first controller selects the third and the fourth levels in case where at least one of the visual-acuity information and the auditory-acuity information is below a predetermined threshold, and the first level in case where the disabled body part information is input.

As discussed, the method and system suitably include use of a controller or processer.

In another embodiment, vehicles are provided that comprise an apparatus as disclosed herein.

### BRIEF DESCRIPTION OF THE DRAWINGS

FIG. 1 represents an example of vehicle elements according to an embodiment of the present disclosure.

FIG. 2 represents an example of controlling procedures for a driver assistance function according to an embodiment of the present disclosure.

FIG. 3 represents an example of detailed controlling procedures for a driver assistance function according to an embodiment of the present disclosure.

FIGS. 4A to 4D represent examples of screen displays of setting procedures for a drive assistance function according to an embodiment of the present disclosure.

### DETAILED DESCRIPTION

Hereinafter, embodiments of the present disclosure will be described in detail with reference to the accompanying drawings, and the same or similar elements will be given the same reference numerals regardless of reference symbols, and redundant description thereof will be omitted. In the following description, the terms “module” and “unit” for referring to elements are assigned and used interchangeably in consideration of convenience of explanation, and thus, the terms per se do not necessarily have different meanings or functions. Further, in describing the embodiments disclosed in the present specification, when it is determined that a detailed description of related publicly known technology may obscure the gist of the embodiments disclosed in the present specification, the detailed description thereof will be omitted. The accompanying drawings are used to help easily explain various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although terms including ordinal numbers, such as “first”, “second”, etc., may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

In addition, the term “unit” or “control unit” included in the names of a hybrid control unit (HCU), a motor control unit (MCU), etc. is merely a widely used term for naming a controller that controls a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In the embodiments of the present disclosure, a driver assistance function is suggested to be controlled with cognition, reaction or manipulation ability lowered due to ages or physical disability taken into consideration.

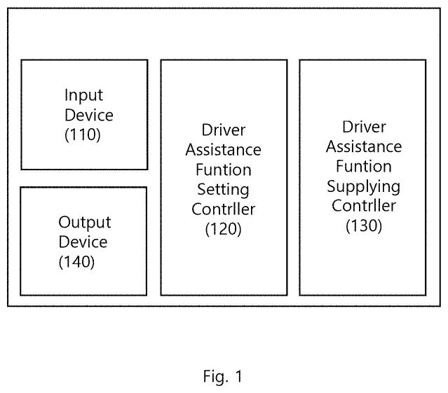

The FIG. 1 represents an example of vehicle elements according to an embodiment of the present disclosure.

In reference to the FIG. 1, a vehicle 100 according to an embodiment may comprise an input device 110, a controller 120 for setting a driver assistance function, a controller 130 for supplying a driver assistance function, and an output device 140. Though the FIG. 1 only shows the elements mainly relevant to an embodiment of the present disclosure, it is obvious that the vehicle 100 may further comprise more elements including the ones such as a powertrain, a controller for controlling the powertrain, various sensors, etc. In the below description, each element will be described in detail.

The input device 110 may comprise at least one device for allowing a driver to input a command or a reaction. For example, the input device 110 may comprise key buttons, a dial, a touch pad, a touch screen, a steering wheel, a pedal, etc. to which the present disclosure is not limited.

The function-setting controller 120 may determine the scope or settings for supplying the driver assistance function based on information input from the input device 110 or a test result, and control the function-supplying controller 130 based on the determined results.

The function-supplying controller 130 may control an activation of the corresponding driver assistance function, a change/application of settings by function, etc. according to the determination and control of the function-setting controller 120. For example, the function-supplying controller 130 may comprise an ADAS controller, an ANN (Audio Video Navigation) system, an e-Call (Emergency Call) controller, etc. to which the present disclosure is not limited.

The output device 140 may comprise means for transmitting to the driver a warning or information through at least one of sight, hearing, and touch. For example, the output device 140 may comprise at least one of a display of an AVN system, a cluster, a speaker, a vibrating seat, a haptic steering wheel, etc.

In the below description, a method for controlling a driver assistance function according to one embodiment of the present disclosure will be described based on the above described vehicle elements.

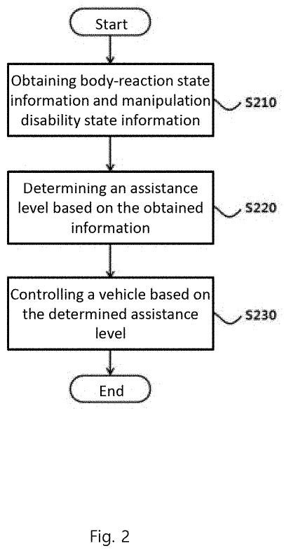

The FIG. 2 represents an example of controlling procedures for a driver assistance function according to an embodiment of the present disclosure.

In reference to the FIG. 2, at first, at least one of body-reaction state information and manipulation disability state information may be obtained (S210). The body-reaction state information is related to situation cognition and reaction, and may be obtained via at least one of inputting and detecting through the input device 110. In case of the inputting, age, visual acuity, auditory acuity, etc. may be input in single numeric value (e.g. visual acuity 1.0) or scope/state (e.g. good, normal, lightly-disabled), and in case of the detecting, test instructions may be provided through the output device 140 and the delay of the driver's reaction or the accuracy input through the input device 110 may be detected, which the present disclosure is not limited to. Also, the manipulation disability state information may be obtained via body parts (e.g. right arm, left leg, etc.) being selected as being disabled in relation to manipulation of the vehicle. The obtained information may be stored in the function-setting controller 120, preferably in a non-volatile memory.

The function-setting controller 120 may determine (i.e. select) an assistance level for the driver assistance function based on the obtained one of the body-reaction state information and the manipulation disability state information (S220). Even though the determination of an assistance level may mean to select one among a plurality of levels comprising several upper and lower levels, it is assumed for the sake of describing convenience in the below description that each level is a ‘mode’ which has settings for more than one function and is individually determined for whether to be applied. For example, in this embodiment, it is assumed that there are 5 levels of A, B, C, D and E each of which is able to be applied selectively and is not related to any other in upper-and-lower or dependency relationship. It should be noted that obviously this is only an example and there can be variants. Detailed examples of respective levels are as follows.

Level A—safe driving assistance mode: acceleration-pedal-system/brake-pedal-system (APS/BPS) sensitivity adjusting logic on, when-the-APS/BPS-excessively-pressed-by-a-driver speed limiting logic on.

Level B—safe road recommendation mode: path recommendation with a higher priority for roundabouts, path recommendation with non-protective left turns avoided. This is based on that elderly drivers cause more car accidents while turning left and so the road type of elderly-drivers' car accidents is comparatively apparent.

Level C—vibration/sound on mode: danger alert through a steering-wheel vibration when collision/obstacle-detection occurred. This is for the sake of assisting effectively drivers having diminished eyesight (low visual acuity and narrow viewing angle) or diminished hearing. In particular, in case of elderly drivers, it is possible to assist narrow-viewing-angled drivers via transmitting information on a location of an obstacle through the correspondingly-located speaker sound according to a detection of a left/right side obstacle.

Level D—cognitive-scope broadening mode: enlargement of a danger-alert range within a sensing scope of a vehicle-surrounding-detection based assistance function such as Forward Collision-avoidance Assist (FCA) function, Blind-spot Collision-Avoidance Assist (BCA) function, etc. (e.g. activation of a danger alert within 10 m in default settings→activation of a danger alert within 15 m). This is for allowing longer time of reaction through an early alert in case where the reaction speed is reduced.

Level E—emergency report all-the-time on mode: storing all the time a vehicle location and transmitting the vehicle location and input driver information to an emergency rescuing entity such as 119 when an accident detected.

The function-setting controller 120, when an assistance level determined, may control (e.g. transmit whether-to-activate or setting values for a function related to the level to) at least one among the function-supplying controllers 130 related to the level for the vehicle to be controlled at the level (S230).

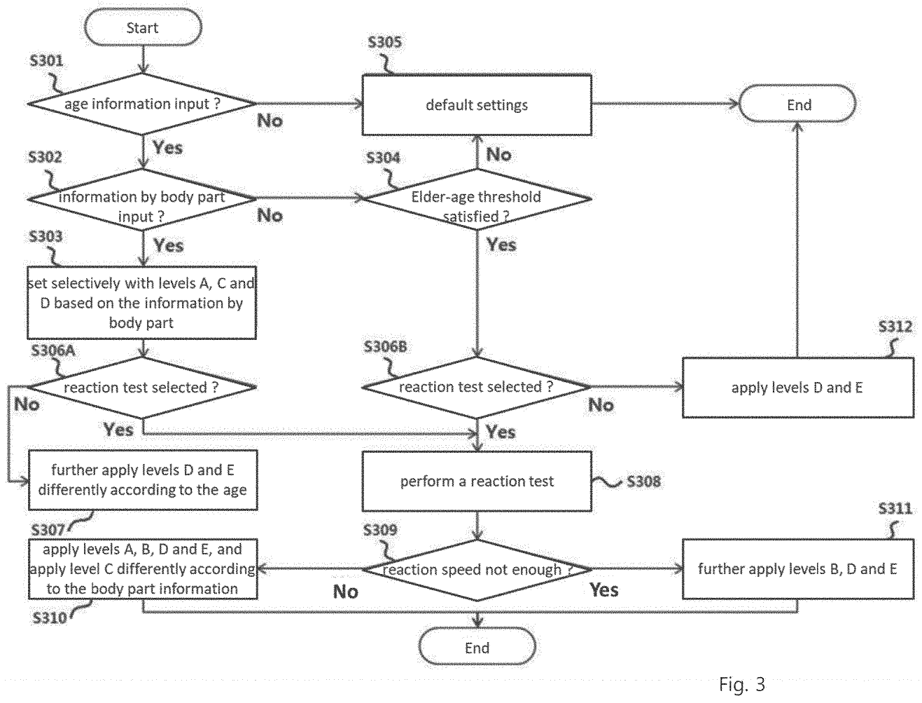

In reference to the FIG. 3, more detailed example is described for the controlling procedures of the driver assistance function described above with reference to the FIG. 2.

The FIG. 3 represents an example of detailed controlling procedures for a driver assistance function according to an embodiment of the present disclosure.

In reference to the FIG. 3, a driver may input his or her age information through the input device 110 in case where a setting menu is accessed through manipulations of a user setting menu (USM) or an AVN system (Yes in S301).

After the age information input (Yes in S301), information on body parts may be input (Yes in S302). The information may comprise a visual acuity, an auditory acuity, a disabled body part, etc. (i.e. manipulation disability state information).

After the age information and the body parts information input, the function-setting controller 120 may selectively set the assistance level to be at least one corresponding level, among the levels A, C, and D, based on the input information. For example, the level C or D may be selected to set the driver assistance function where the visual acuity or the auditory acuity is below a threshold level, and the level A may be selected to set the function where there is a disabled body part (S303).

In case where the age is input but the body parts information is not input (No in S302), The function-setting controller 120 may determine whether the input age information satisfies a predetermined elder-age (e.g. 60 and older) threshold (S304). In case where the age does not satisfy the elder-age threshold (No in S304) nor is the age information input (No in S301), the driver assistance function may be operated with default settings (or current individual settings for function) (S305).

On the other hand, in case where both of the age information and the body parts information are available, whether to perform a reaction test may be determined according to the driver's intention (S306A). In case of not performing the reaction test (No in S306A), if the age information satisfies the elder-age threshold, the level D (when it is not applied in S303) and the level E may be further applied (S307).

Even in case where the body parts information is not input and the elder-age threshold is satisfied (Yes in S304), whether to perform the reaction test may be determined according to the driver's intention (S306B). When the reaction test not performed (No in S306B), the level D and the level E may be applied (S312).

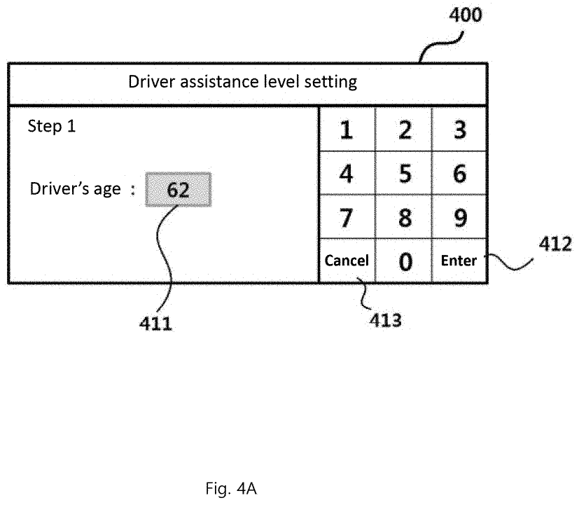

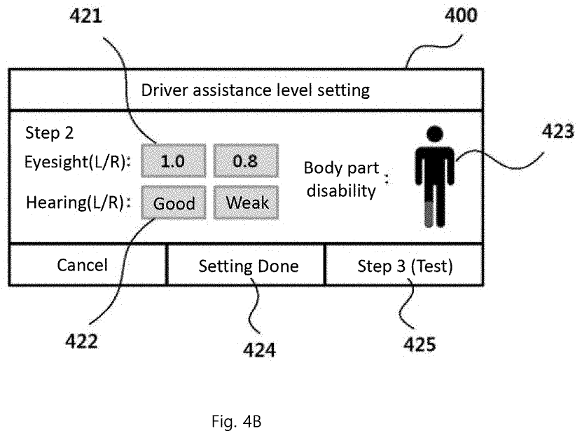

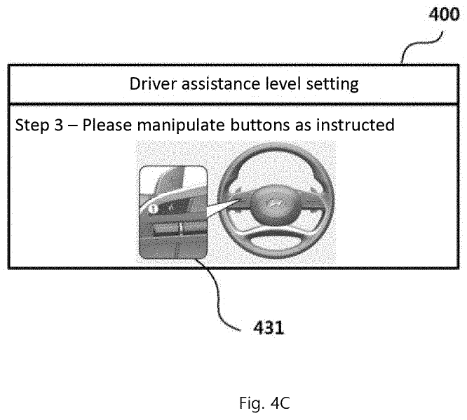

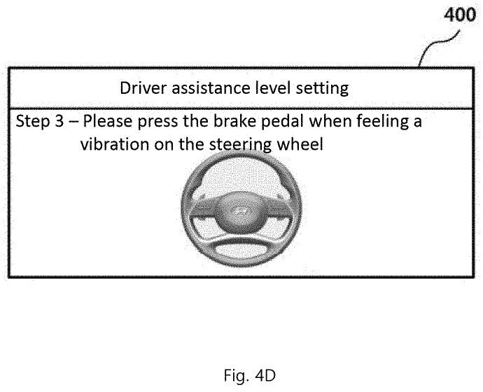

In case where the reaction test is determined to be performed in the step 306A or S306B, The function-setting controller 120 may perform the reaction test by using the input device 110 and the output device 140 (S308). Details of the reaction test will be described in reference to the FIGS. 4C and 4D.

According to a result of the test, if it is determined in the function-setting controller 120 that the reaction speed is not enough (i.e. slow) compared to a predetermined threshold (No in S309), the levels A, B, D and E are basically applied and whether to apply the level C may be finally determined according to the body parts information (e.g. the level C is applied when a visual acuity being below a threshold) (S310).

On the contrary, if the reaction speed is determined to be enough compared to the predetermined threshold (Yes in S309), the function-setting controller 120 may apply the levels B, D and E.

On the other hand, in the procedure described in the FIG. 3, when determining an application of each level, i) the based information for the determination may be directly input by the driver (S301, S302, etc.), or ii) the reaction test result may be used. It should be noted that it is only an example and the manner of determining whether to apply for each level is not necessarily limited thereto. According to another embodiment, while a driver is driving, the driver's manipulations and the corresponding vehicle behaviors and surroundings at the time may be stored and accumulated, and the stored information may be machine-learned for application of each level to be determined by an AI (Artificial Intelligence). For example, body-reaction state information and manipulation disability state information may be generated by using information obtained through Lane Keeping Assistance System (LKAS) on whether the vehicle is kept well in a lane, the steering angles follow well along the curve when the vehicle running on a curved road having a curvature larger than a predetermined value, etc. before the Lane Keeping Assistance System interferes. For another example, a driver's reaction speed against a (suddenly) appeared forward obstacle may be obtained through Forward Collision-Avoidance Assist System (FCAS) and machine-learned cumulatively.

In addition, in case where at least one level is further applied (S311) according to a determination based on the test result (S309) after the test performed (S308), a popup window informing the application or information for obtaining the driver's final confirmation for the application may be output on a display of the cluster or the AVN system before the application made.

The FIGS. 4A to 4D represent examples of screen displays of setting procedures for a drive assistance function according to an embodiment of the present disclosure.

Commonly in the FIGS. 4A to 4D, it is assumed that the setting of the driver assistance function is made through a user interface output on a display 400 of the AVN system. Also, the detailed menu contents described in the FIGS. 4A to 4D are only examples and it is obvious to the skilled person in the art that they can be varied.

First, in reference to the FIG. 4A, as a driver assistance level setting menu accessed through a few manipulations of menu, a driver's age input menu corresponding to the step S301 of the FIG. 3 may be displayed. Even though it is shown that the driver's age can be input in the input field 411 by numbers being input through the keypad, it is sure that the age can be selected by drop-downs in the input field 411. If the ‘Enter’ button 412 is selected after the age information input, it may be proceeded to the ‘Yes’ of the step S301 in the FIG. 3, and if the ‘Cancel’ button 413 selected, it proceeded to the ‘No’ of the step S301.

Next, in reference to the FIG. 4, the body parts information input menu is shown which corresponds to the step S302 which is carried out in case of the ‘Yes’ of the step S301 in the FIG. 3. The body parts information input menu may comprise a visual-acuity filed 421, an auditory-acuity field 422 and a body image 423.

When a body part selected as a disabled part in the body image 423, a visual effect may be applied differently from the remaining parts.

If the ‘Setting Done’ button 424 is selected after the input of each field and the selection of a disabled body part finished, it may be proceeded to the ‘No’ of the step S306A in the FIG. 3, and if the ‘Test’ button 425 selected, it proceeded to the ‘Yes’ of the step S306A.

If the ‘Test’ button 425 is selected, the elapsed time until the manipulation of the input device 110 in response to an output from specific output means of the output device 140 may be measured.

For example, in reference to the FIG. 4C, driver's reaction ability may be measured by the elapsed time until the input being detected through the input device 110 of which specific input means, e.g. steering wheel buttons, is instructed as an image 431, and whether the input is conducted exactly through the instructed buttons not others.

For another example, as shown in the FIG. 4D, the driver's reaction ability may be measured by whether the brake pedal is manipulated after the steering wheel vibrated as instructed, and the elapsed time from the start of the vibration to the manipulation of the pedal.

Even though, in the above described embodiments, the application of the levels B and D is determined according to whether the age information satisfies the elder-age threshold, there may be a plurality of thresholds so that applied levels can be differentiated based on the corresponding age groups.

On the other hand, the present disclosure described above may be embodied as computer-readable code on a medium in which a program is recorded. The computer-readable medium includes all types of recording devices in which data readable by a computer system is stored. Examples of the computer-readable medium include a hard disk drive (HDD), a solid-state drive (SSD), a silicon disk drive (SDD), a ROM, a RAM, a CD-ROM, a magnetic tape, a floppy disk, an optical data storage device, etc. Therefore, the above detailed description should not be construed as restrictive and should be considered as illustrative in all respects. The scope of the present disclosure should be determined by a reasonable interpretation of the appended claims, and all modifications within the equivalent scope of the present disclosure are included in the scope of the present disclosure.

What is claimed is:

1. A method for controlling a driver assistance function, the method comprising:
obtaining at least one of body-reaction state information and manipulation disability state information, the body-reaction state information related to a driver's situation cognition and reaction and the manipulation disability state information being for physical disability in relation to manipulation of a vehicle;
selecting via a controller at least one assistance level corresponding to the obtained information among a plurality of assistance levels, each level corresponding to a different driver assistance function; and
conducting via a controller control of the vehicle based on the selected at least one assistance level.

2. The method of claim 1, wherein the plurality of assistance levels comprise at least two of:
a first level accompanied by pedal sensitivity control and speed limiting;
a second level for providing with a path recommendation avoiding a specific turn;
a third level for activating haptic or auditory output in response to detected surrounding information;
a fourth level for enlarging a sensor-based alert output range; and
a fifth level for preparing all the time information for emergency report.

3. The method of claim 2, wherein the obtaining step comprises a step of receiving as input the driver's age information as the body-reaction state information.

4. The method of claim 3, wherein the obtaining step further comprises a step of receiving as input information by body part as the body-reaction state information and the manipulation disability state information.

5. The method of claim 4, the method further comprising a step of conducting the control of the vehicle according to default settings in case where the age information is not input, or the information by body part is not input nor does the age information satisfy a predetermined elder-age threshold.

6. The method of claim 4, wherein the step of receiving the information by body part comprises the steps of:
receiving as input at least one of the driver's visual-acuity information and auditory-acuity information as the body-reaction state information; and
receiving as input disabled body part information as the manipulation disability state information.

7. The method of claim 6, wherein the step of selecting the assistance level comprises a step of selecting the third and the fourth levels in case where at least one of the visual-acuity information and the auditory-acuity information is below a predetermined threshold.

8. The method of claim 6, wherein the step of selecting the assistance level comprises a step of selecting the first level in case where the disabled body part information is input.

9. The method of claim 3, further comprising a step of conducting a reaction test in the vehicle as so selected by the driver,
wherein the selection of the assistance level is made with a result of the test taken further into consideration.

10. The method of claim 9, wherein the step of selecting the assistance level comprises a step of selecting the first, the second, the fourth and the fifth levels in case where the reaction speed is not enough according to the result of the test.

11. The method of claim 9, wherein the step of selecting the assistance level comprises a step of selecting the second, the fourth, and the fifth levels in case where the reaction speed is enough according to the result of the test.

12. The method of claim 1, wherein, for each assistance level, whether or not to apply is individually selected.

13. A computer-readable storage medium storing a program for implementing the method of claim 1.

14. A vehicle comprising:
an input device configured to obtain at least one of body-reaction state information and manipulation disability state information, the body-reaction state information related to a driver's situation cognition and reaction and the manipulation disability state information being for physical disability in relation to manipulation of a vehicle;
a first controller configured to select at least one assistance level corresponding to the obtained information among a plurality of assistance levels, each level corresponding to a different driver assistance function; and
a second controller configured to conduct control of the vehicle based on the selected at least one assistance level.

15. The vehicle of claim 14, wherein the plurality of assistance levels comprise at least two of:
a first level accompanied by pedal sensitivity control and speed limiting;
a second level for providing with a path recommendation avoiding a specific turn;
a third level for activating haptic or auditory output in response to detected surrounding information;
a fourth level for enlarging a sensor-based alert output range; and
a fifth level for preparing all the time information for emergency report.

16. The vehicle of claim 15, wherein the input device receives as input the driver's age information as the body-reaction state information.

17. The vehicle of claim 16, wherein the input device receives as input information by body part as the body-reaction state information and the manipulation disability state information.

18. The vehicle of claim 17, wherein the first controller is further configured to control the second controller to conduct the control of the vehicle according to default settings in case where the age information is not input, or the information by body part is not input nor does the age information satisfy a predetermined elder-age threshold.

19. The vehicle of claim 17, wherein the input device, as the information by body part, receives as input at least one of the driver's visual-acuity information and auditory-acuity information as the body-reaction state information, and disabled body part information as the manipulation disability state information.

20. The vehicle of claim 19, wherein the first controller is further configured to select the third and the fourth levels in case where at least one of the visual-acuity information and the auditory-acuity information is below a predetermined threshold, and the first level in case where the disabled body part information is input.
